(19) United States
(12) Patent Application Publication
(10) Pub. No.: US 2015/0113539 A1
(43) Pub. Date: Apr. 23, 2015

(54) METHOD FOR EXECUTING PROCESSES ON A WORKER MACHINE OF A DISTRIBUTED COMPUTING SYSTEM AND A DISTRIBUTED COMPUTING SYSTEM

(71) Applicants: Sachin Agarwal, Waterloo (CA); Krisantus Sembiring, Muenchen (DE); Andreas Beyer, Heidelberg (DE)

(72) Inventors: Sachin Agarwal, Waterloo (CA); Krisantus Sembiring, Muenchen (DE); Andreas Beyer, Heidelberg (DE)

(73) Assignee: NEC EUROPE LTD., Heidelberg (DE)

(21) Appl. No.: 14/402,409

(22) PCT Filed: May 25, 2012
(86) PCT No.: PCT/EP2012/059911

§ 371 Date: Nov. 20, 2014

(51) Int. Cl. G06F 9/50

(52) U.S. Cl. CPC G06F 9/5088
USPC 718/104

(57) ABSTRACT

The invention relates to a method for executing processes, preferably media processes on a worker machine of a distributed computing system, with a plurality of worker machines, comprising the steps of a) Selecting one of the worker machines out of the plurality of worker machines for execution of a process to be executed in the distributed computing system and transferring said process to the selected worker machine, b) Executing the transferred process on the selected worker machine, and c) Removing the executed process from the selected worker machine after finishing of the execution of the process, wherein statistical information of resource usage of the process to be executed on one of the worker machines is collected and that the selection of the worker machine is based on a probability resource usage qualifier, wherein the probability resource usage qualifier is extracted from combined statistical information of the process to be executed and already executed and/or executing processes on the worker machine. The invention relates also to a system and a use.

The present invention relates to a method for executing processes, preferably media processes on a worker machine of a distributed computing system, with a plurality of worker machines, comprising the steps of
a) Selecting one of the worker machines out of the plurality of worker machines for execution of a process to be executed in the distributed computing system and transferring said process to the selected worker machine,
b) executing the transferred process on the selected worker machine, and
c) removing the executed process from the selected worker machine after finishing of the execution of the process.

The invention relates also to a distributed computing system for executing processes, preferably media processes, and preferably for execution with the method according to one of the claims 1-14, comprising a plurality of worker machines for execution of processes in the distributed computing system and an inserter for selecting one of the worker machines out of the plurality of worker machines for execution of a process to be executed and for transferring said process to the selected worker machine for execution.

Distributed computing systems provide computation, network and storage resources for applications for example via the ability to spawn worker machines on demand. However, these resources, in particular each process been executed and each transmitted data for the execution may be measured and also be billed. Therefore an efficient resource usage is important for a cost-affective distributed computing system. Resources like central processing unit, network bandwidth, IP addresses, storage and/or memory need to be efficiently provisioned in order to balance a certain quality of service with a minimum possible resource usage.

One approach to address this problem is so called load balancing. Load balancing distributes work load across multiple worker machines, network links, central processing units or other resources to achieve efficient resource utilization. Processes or “jobs” are distributed among worker machines for execution. To avoid an overload of a certain worker machine by deploying too many processes on that machine, load-balancing simply counts the number of processes on each worker machine and deploys only additional processes if a predefined threshold for the number of processes to be executed is not exceeded.

However, load balancing has certain significant drawbacks. One of the drawbacks is, that load balancing assigns processes to be executed on worker machines by simply counting the number of processes on or for each worker machine. If a process terminates on one worker machine a process to be executed is transferred to that worker machine even if for example it is one of a slower type of working machines and the process to be executed would need a very long time to be completed.

Another drawback is, that if multiple worker machines for execution of a process are available, a process is transferred to one of the worker machines even if another one of the available worker machines would be more suitable for execution of this process. A further drawback is, that the following situation might occur: A number of processes is executed in the distributed computing system, however one process per worker machine. This might result in an inefficient resource usage, when for example processes only need two percent of the resources of each worker machine.

An even further disadvantage is that load balancing is inflexible since different kind of processes, for example streaming a video and a scientific process calculating floating point algorithms would not be taken into account. This leads to a bad quality-of-service and inefficient resource usage.

It is therefore an objective of the present invention to provide a method and a distributed computing system for executing processes which are more flexible with regard to different kind of processes and the variability of resource usage.

It is a further objective of the present invention to provide a method and a distributed computing system for executing processes enabling a more efficient selection of worker machines for different processes with regard to resource usage while providing a certain quality-of-service level.

According to the invention the aforementioned objectives are accomplished by a method of claim 1, a system of claim 15 and a use according to claim 18.

According to claim 1 the method for executing processes, preferably media processes on a worker machine of a distributed computing system, with a plurality of worker machines, comprising the steps of
a) Selecting one of the worker machines out of the plurality of worker machines for execution of a process to be executed in the distributed computing system and transferring said process to the selected worker machine,
b) executing the transferred process on the selected worker machine, and
c) removing the executed process from the at least one worker machine after finishing of the execution of the process.

According to the invention the method according to claim 1 is characterized in that statistical information of resource usage of the process to be executed on one of the worker machines is collected and that the selection of the one worker machine is based on a probability resource usage qualifier, wherein the probability resource usage qualifier is extracted from combined statistical information of the process to be executed and already executed and/or executing processes on the worker machine.

According to claim 15 the distributed computing system for executing processes, preferably media processes, and preferably for execution with the method according to one of the claims 1-14, comprising a plurality of worker machines for execution of processes in the distributed computing system and an inserter for selecting one of the worker machines out of the plurality of worker machines for execution of a process to be executed and for transferring said process to the selected worker machine for execution.

According to claim 15 the distributed computing system is characterized by the inserter being operable to select one worker machine based on a probability resource usage qualifier, wherein the probability resource usage qualifier is extracted from combined statistical information of the process to be executed and already executed and/or executing processes.

According to claim 18 the method according to one of the claims 1-14 and/or the distributed computing system according to one of the claims 15-17 is used for executing media processes.

The term “probability resource usage qualifier” means preferably in the description in particular in the claims a value representing a value for a probability of a usage of a resource of the distributed computing system by a process to be executed on the distributed computing system, for example the probability of a resource usage of 50% of a process on a worker machine.

According to the invention it has first been recognized, that the ability to trade-off quality-of-service control with required resources is significantly enhanced by taking into account the variability of resource demands of processes across time, thus providing a dynamic and adaptive method and system.

According to the invention it has further been first recognized that the present invention enables to continuously learn process characteristics from historical data and use this data in selecting a worker machine for future processes to be executed resulting in precise predictions of resource usage of processes.

Further features, advantages and preferred embodiments are described in the following subclaims.

According to a preferred embodiment the process is classified into a process class according to statistical information of resource usage of a process to be executed, wherein processes in the same process class have similar resources usage characteristics. A faster and more efficient way and an even more precise determination of a process to be executed according to similar resource usage characteristics is provided. This leads further to an efficient and a fast selection of a worker machine to execute the classified process.

According to a further preferred embodiment processes in the same process class have the same type of content data, preferably media content data, to be processed. Processes in particular defined by same repetitive tasks to be performed are grouped and therefore allowing a fast and precise selection of worker machines for execution of these processes.

According to a further preferred embodiment worker machines having no processes to execute are either shutdown or assigned to be slack machine, wherein a slack machine is kept idle for execution of future processes. This enhanced the overall redundancy of the distributed computing system: An incoming process for execution in the distributed computing system can be executed immediately be moving this process to a slack machine. Since only a fraction of slack machines are needed the other worker machines having no processes to execute are shutdown for energy saving.

According to a further preferred embodiment a process on a first worker machine having a first probability resource usage qualifier is moved to a second worker machine having a second probability resource usage qualifier when the second probability resource usage qualifier is higher than the first probability resource usage qualifier. This enables a squeezing out of inefficient processes and allocations. Another advantage is, that this enables an easy decision of which worker machine is to be chosen for a new process and/or of processes already executed without reducing the quality-of-service.

According to a further preferred embodiment a moving of a process to another worker machine is checked when another process on a worker machine is terminated on that worker machine. By comparing probability resource usage qualifiers when a process has terminated, i.e. finally removed from the worker machine probability resource usage qualifiers and/or a number of slack machines may change. Therefore the overall resource allocations in the distributed computing system also change. Thus, a process is only moved when another process is terminated enables with a minimum of checking an even more efficient resource usage in the distributed computing system. Further working machines may be freed of all processes so that they may be turned of or idled saving energy.

According to a further preferred embodiment a moving of a process to another worker machine is only performed if the number of worker machines having an inefficient resource usage is below a fragment threshold. Such a fragment threshold is a constant specifying for example the number of worker machines that may be allowed to have inefficient resource or process allocations. This prevents processes moving across the worker machines in the distributed computing system too frequently. Thus, data transmission between worker machines is minimized and frequent pausing of processes while being moved from one worker machine to another is reduced.

According to a further preferred embodiment the number of slack machines is determined according to a parameter, wherein the parameter is dependent on process classes, statistical information of processes to be executed and/or executing and/or the rate of processes to be executed and/or terminated on the distributed computing system. This enables a flexible and dynamic adjustment of the number of slack machines to be provided for future execution of processes by the distributed computing system.

According to a further preferred embodiment process classes are determined by K-means clustering, hierarchical clustering, using of neural networks and/or using of support vector machine. Neural networks for example provide self learning and therefore self definition of process classes based on processes already executed in the distributed computing system, whereas K-means clustering enables a fast finding of a center of statistical information forming then a basis of a process class.

According to a further preferred embodiment resource usage of processes executed on the distributed computing system are collected periodically. This allows a data analysis of actual resource usage of processes in real time to discover more efficiently statistical patterns of resource usage on a per-process basis and an enhanced classification of processes into different process classes. Further a selection of worker machines for execution of processes is more precise.

According to a further preferred embodiment the probability resource usage qualifier represents a probability of a process exceeding a predefined maximum usage on a worker machine. This enables a flexible way to avoid a usage of worker machine over its maximum resource capability. Another advantage is that this enables a precise definition to determine how much resources of the worker machine should be assigned to a process or processes on a worker machine.

According to a further preferred embodiment the combined statistical information of the process to be executed and already executed and/or executing processes on a worker machine are weighted for extraction of the probability resource usage qualifier. This enables to adapt the calculation of the probability resource usage qualifier in a flexible way. For example current and/or more recent executed processes can be preferred when calculating the probability resource usage qualifier avoiding that old, i.e. information of processes finished long ago, have still significant influence on the classification into a process class and on the selection of a worker machine for execution of a process.

According to a further preferred embodiment the probability resource usage qualifier for media processes following a Gaussian distribution for resource usage is based on the corresponding Q-function. This enables a precise forecast of resource usages of media processes to be executed. Media processes include for example demultiplexing, decoding, mixing, resampling, encoding and/or multiplexing of audio/video content and perform continuous repetitive actions. For example audio or video data composed of frames is processed and a written out continuously on a frame-by-frame basis. The Q-function which is proportional to the complementary error function computes a probability for a variable, for example specifying cpu or memory allocation on a worker machine, wherein resource usage of the processes executed and/or executing are Gaussian distributed with a certain means and a certain variance, having a value greater than a predetermined maximum allowed cpu or memory allocation. Since the Q-function is well computable respectively calculated a fast and efficient determination of the probability resource usage qualifier for media processes is provided.

According to a further preferred embodiment the worker machine having the highest probability resource usage qualifier below certain threshold is selected for execution of the process. One of the advantages is that this enables an easy determination, which worker machine to be used for execution of incoming as well as existing processes, wherein the latter could then be moved to the worker machine with the highest probability resource usage qualifier. A further advantage is that a moving of a process to a worker machine less suitable for execution of the process is avoided.

According to a preferred embodiment of the distributed computing system according to claim 15 the distributed computing system comprises a classifier for classifier the process to be executed into a process class, wherein processes in the same process class have similar resource usages. A faster and more efficient way and an even more precise determination of a process to be executed according to similar resource usage characteristics is provided. This leads further to an efficient and a fast selection of a worker machine to execute the classified process.

According to a preferred embodiment of the distributed computing the distributed computing system comprises a model generator for generating and/or updating a model for different process classes, preferably based on data from executed and/or executing processes. The model generator generates a model from historical records of all processes already executed and enables to train the model for classifying new processes by the classifier. This training of the model may be then be periodically performed to update statistical information of process classes as more training data is available by executing and/or executed processes.

There are several ways how to design and further develop the teaching of the present invention in an advantageous way. To this end it is to be referred to the patent claims subordinate to patent claim 1 and claim 15 on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will we explained.

In the drawings

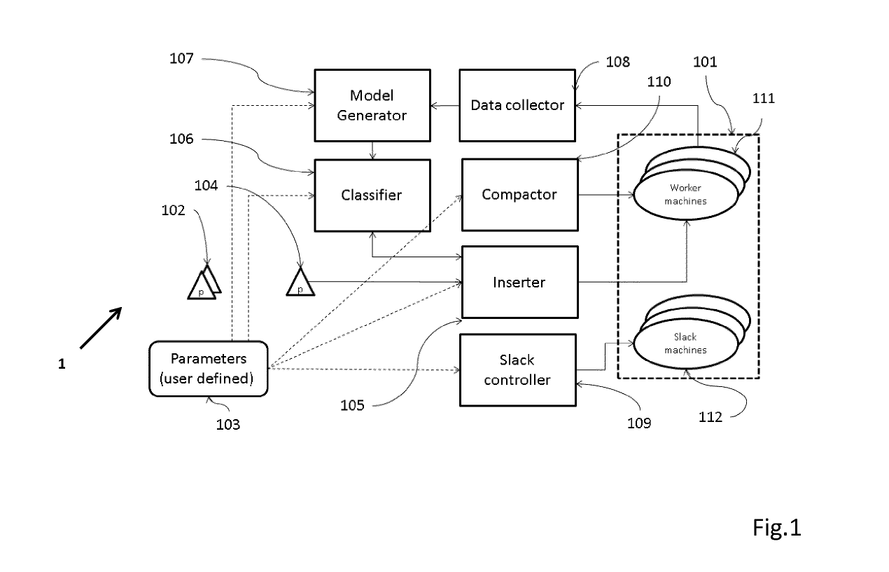

FIG. 1 shows a distributed computing system according to a first embodiment of the present invention;

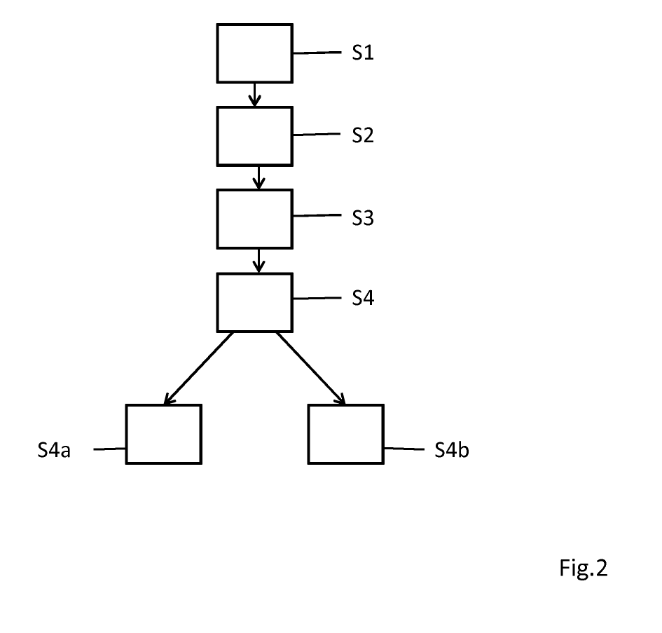

FIG. 2 shows a flowchart of a part of a method according to a second embodiment of the present invention;

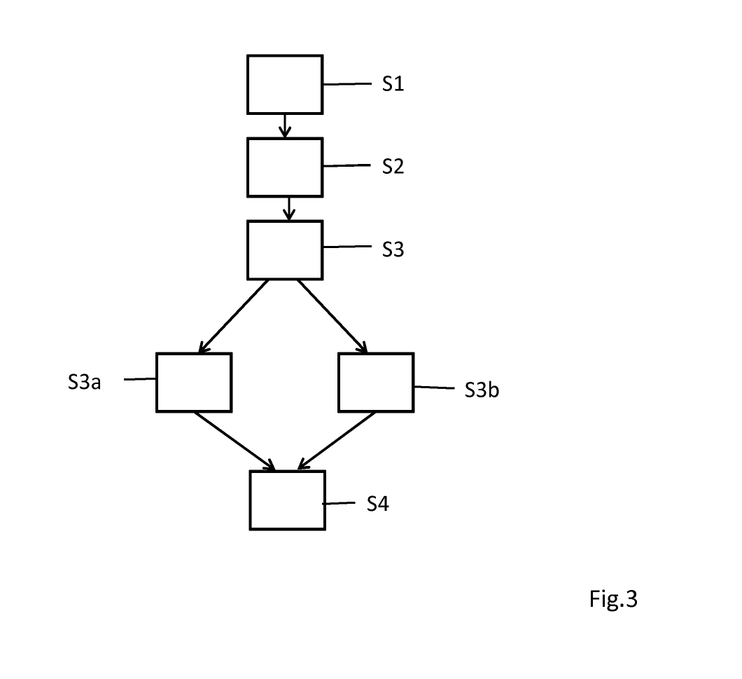

FIG. 3 shows a flowchart of a part of a method according to a third embodiment of the present invention and

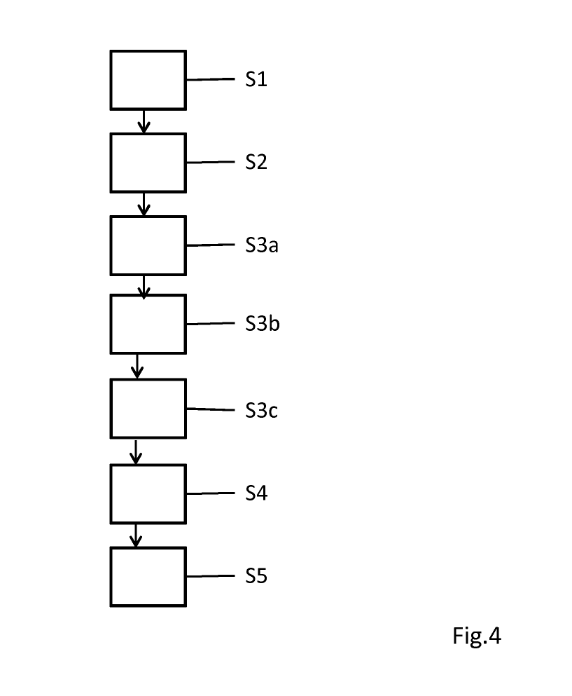

FIG. 4 shows a flowchart of a part of a method according to a fourth embodiment of the present invention.

FIG. 1 shows a distributed computing system according to a first embodiment of the present invention.

In FIG. 1 a schematic view of a high level component architecture of a system according to the present invention is shown. Arrows with dash lines indicate main interactions and associations between different components shown in FIG. 1.

Reference sign 101 denotes resources. Resources 101 may be computational, network or storage resources. Resources 101 may be part of a processing cloud offering central processing unit resources. These resources 101 include worker machines 111 and slack machines 112. Worker machines 111 are actual computing nodes which execute processes in a distributed computing system 1. Each worker machine 111 has at least one process assigned to it by an inserter 105. When all processes on a worker machine terminate or moved to other worker machines the worker machine 111 becomes a slack machine 112. Slack machines 112 are spawned by a slack controller to maintain a controlled redundancy in the distributed computing system 1. These can be assigned processes and made worker machines 111 when needed or they can be shut down if more slack machines 112 are running than intended by the slack controller 109.

Reference 102 denotes processes that use the resources 101 to perform tasks. Processes 102 may arrive for processing at different times during their course of execution and can terminate at any time.

Reference sign 103 denotes parameters wherein the parameters 103 control a functioning of components of the distributed computing system 1. These parameters 103 are provided by a user. If for example an incoming process 104, which is an instance of a process that needs to be run in the distributed computing system 1 the incoming process 104 arrives at the inserter 105 of the distributed computing system 1. The inserter 105 receives the incoming processes 104 and uses information from a process classifier 106 to ascertain resource usage characteristics of the incoming process 104. The inserter 105 holds a global view of all resources 101 available for each worker machine 111. The inserter 105 further maps the incoming process 104 to an appropriate worker machine 111 based on the Q-function of the sum of processes running on the worker machines 111 and further parameters.

The classifier 106 may be provided in form of a machine learning means based on SVM or K-means clustering to map the incoming process 104 to a predefined or known process class. The classifier 106 also reports summary statistical information like mean and variance of the process class to the inserter 105. If the classifier 106 is unable to classify a process with a certain level of confidence, the classifier 106 may also signal the inability to classify the process to the inserter 105. The inserter 105 may then invoke routines to deal with a non-classifiable, i.e. unknown type of process.

To obtain statistical information, a data collector 108 collects per-process resource usage statistics and generates per-process summary statistics for subsequent use by the model generator 107 and the inserter 105 to update these statistics parallel processing methods such as incremental map-reduce may be used. The data collector 108 periodically collects these data and updates the underlying statistical information of the process classes as more statistical information is available and collectable by already executed processes. These collected statistical information for the process classes may be appropriately weighted assigned to newer and older statistical data of executed processes.

To control the assignment of worker machines 111 and slack machines 112 a slack controller 109 is responsible for maintaining adequate spare capacity in the distributed computing system 1 so that new processes to be executed via the distributed computing system 1 do not have to wait for worker machines 111 to be turned on before they are deployed on them.

Further a compactor 110 is provided for performing a moving of already running processes between worker machines 111 in order to “de-fragment” the worker machines 111: If the execution of a process on a worker machine 111 is terminated processes may become distributed in a suboptimal way across the worker machines 111. The compactor 110 moves then processes from one worker machine 111 to another worker machine 111 so that some worker machines may be freed from all running processes. These worker machines 111 can then be subsequently turned off or idled. The compactor 110 decides when and how processes are moved. These decisions are based on statistical information of the processes running on the other worker machines and in potential moving processes and on parameters, specifying for example the maximum number of worker machines shutdown and/or idled.

In the FIG. 2-4 the following variables or parameters are used.

V is the set of N worker machines labeled v₁, v₂, . . . , v_{N}. The set of worker machines is changing dynamically. The number of worker machines N may vary as worker machines may be booted up or turned off.

P is a set of M processes p₁, p₂, . . . , p_{M} The set of processes running changes dynamically; M may change as processes start or terminate.

Each worker machine vⱼεV executes a subset of processes Pⱼ s.t. U_{k=1 . . . N}Pₖ=P, with Pₐ∩P_{b}=Ø∀a≠b.

A quality-of-service constant q is introduced which is the maximum acceptable value of the Q-function for the desired quality-of-service, wherein the Q-function is defined as follows

$$Q ( x ) = \frac{1}{2 } erfc ( \frac{x - μ}{σ \sqrt{2}} )$$

with x representing for example a maximum allowed CPU usage on a worker machine.

fragmentedThreshold is a constant specifying the number of worker machines that may be allowed to have inefficient process allocations, wherein fragmentedThreshold≦N. This avoids a too frequent process moving across the worker machines. fragmentedMachineCtr is the actual number of worker machines with sub-optimum process allocations which is initialized to 0 at start and varies during the distributed computing system's operation.

The slack s is a positive integer specifying the number of worker machines to be kept idle in anticipation of a future processing demand. The corresponding slack worker machine set is defined by S={v₁, v₂, . . . , vₛ}, V∩S=Ø·s can be a constant or a parameter dependent on the statistical information of the processes or an incoming process rate.

FIG. 2 shows a flowchart of a part of a method according to a second embodiment of the present invention.

In FIG. 2 a new process is inserted into the distributed computing system 1. When a new process pᵢ arrives, statistical information of its resource usage, for example mean μ(pᵢ) and standard deviation σ(pᵢ) of its CPU usage or another parameter such as network bandwidth usage is obtained in a first step S1. If the process can be recognized based on its features, e.g. its source code, then statistical training data from previous processes is used to classify the process into a certain process class and reference statistical information from the training data is obtained. Such classification may be performed via machine learning approaches such as K-means clustering, hierarchical clustering, Neural networks, SVM or the like.

If the process cannot be classified, the process pᵢ in v₁εS is run, S=S−{v₁},V=V∪{v₁} is updated in a second step S2 and insertion of the process is completed. The resource usage of process pᵢ will be recorded and its statistical information is computed as time progresses, allowing v₁ to be included in steps S1-S5 of FIG. 4.

In a third step S3 a worker machine vⱼεV is searched such that the processes running on this worker machine set Pⱼ={pⱼ₁, pⱼ₂, . . . p_{jR}} satisfy

$${Q}_{j} = Q ( \frac{x - {μ}_{Total}}{{σ}_{Total}} ) \leq q \qquad ( A )$$

### Wherein

μ_{Total}=μ(pᵢ)+μ(pⱼ₁)+μ(pⱼ₂)+ . . . +μ(p_{jR})

σ²_{Total}=σ²(pᵢ)+σ²(pⱼ₁)+σ²(pⱼ₂)+ . . . +σ²(p_{jR})

(μ_{Total}, σ²_{Total}) are the mean and variance of the total sum of Gaussian distributed resource usages of al processes, if process pᵢ is executed in worker machine vⱼ, and if applicable along with R other processes already executed by the worker machine.

If multiple worker machines can satisfy the above condition (A) then the worker machine with the largest Qⱼ among these is chosen in a fourth step S4.

If such a worker machine vⱼεV is found where the q threshold is satisfied in a first fourth substep S4a the process pⱼ in virtual machine vⱼ is started and sets P and Pⱼ, are updated and insertion of the process is completed.

If no worker machine found, the process pᵢ in v₁εS is run and S=S−{v₁},V=V∪{v₁} is updated and if |s|<s then a new worker machine v_{z} to S, S=S∪{vₓ} is added in a second fourth step S4b.

FIG. 3 shows a flowchart of a part of a method according to a third embodiment of the present invention.

In FIG. 3 steps for removing a terminated process are shown in a flowchart.

When a process pᵢ with μ(pᵢ) mean and standard deviation σ(pᵢ) terminates, the following steps are performed:

In a first step S1 the worker machine vⱼεV where process pᵢ is executing is identified.

In a second step S2 this process is removed from the worker machine, and Pⱼ updated accordingly.

In a third step S3 |Pⱼ|=0 is checked.

If |S|<s, worker machine vⱼ to S, S=S∪{vⱼ} in a first third substep S3a is added otherwise, the worker machine vⱼ, V=V−{vⱼ} is shutdown.

In a second third substep S3b the variable fragmentedMachineCtr is incremented if |Pⱼ|≠0.

In a fourth step S4 if fragmentedMachineCtr>fragmentedThreshold, steps S1-S5 of FIG. 4 are performed in order to compact the processes running on the worker machines.

FIG. 4 shows a flowchart of a part of a method according to a fourth embodiment of the present invention.

In FIG. 4 a flowchart is shown for moving already running processes between different working machines.

In a first step S1 Qᵢ (Q-function) for each worker machine v₁εV is computed.

In a second step S2 the set of all processes in P are written into a list L and L is sorted in descending order of the corresponding Q-functions of each process.

In a third step S3 for process pᵢ running on worker machine vₖ wherein I being the index counter of the list L, starting from 1 and going up to M, the following three substeps S3a-S3c are performed.

In the first third substep S3a a worker machine vⱼεV−{vₖ} is searched such that for the processes in set Pⱼ={pⱼ₁, pⱼ₂, . . . p_{jR}} such that

$${Q}_{j} = Q ( \frac{x - {μ}_{Total}}{{σ}_{Total}} ) \leq q ,$$

and
Qⱼ>Qₖ is satisfied.

Where,

μ_{Total}=μ(pᵢ)+μ(pⱼ₁)+μ(pⱼ₂)+ . . . +μ(p_{jR})

σ²_{Total}=σ²(pᵢ)+σ²(pⱼ₁)+σ²(pⱼ₂)+ . . . +σ²(p_{jR})

This is the mean and variance of the sum of Gaussian distributions that would result should process pᵢ be executed in worker machine vⱼ if applicable along with R other processes already executing in the worker machine.

In the second third substep S3b if multiple worker machines can satisfy the above conditions (step S3a) then the worker machine with the largest Qⱼ among these is chosen.

In the third substep S3c if vⱼεV−{vₖ} is found, pᵢ to vⱼ is moved, and Pⱼ and Pₖ are updated; else it is continued on to the next process in list L with repetition of steps S3, S3a, S3b and S3c.

For each worker machine vⱼεV, it is checked in a fourth step S4 if |Pⱼ|=0 and then if |S|<s, the worker machine vⱼ is added to S, S=S∪{vⱼ}, otherwise, worker machine vⱼ, V=V−{vⱼ} is shutdown.

In a fifth step S5 fragmentedMachineCtr is set to 0

According to FIG. 1-4 all M processes p₁, p₂, . . . , p_{M} periodically report their resource usage, preferably per unit time to the data collector 108. This resource usage data may be first aggregated on each worker machine 111 for processes running in that worker machine 111 and then reported to the data collector 108 periodically. The model generator 107 periodically obtains statistical information from the data collector 108. A specific media-process description parser converts process descriptions of process to be executed into a corresponding feature set. The processes are then classified into the process classes with similar features using machine learning algorithms such as SVM or K-means clustering. The average statistics preferably mean and variance, of members of each process class are then calculated. Newer and older data may be weighted differently while calculating these average statistics. The classifier 106 uses the model generated by the model generator 107 to report the average statistics of a process class to the inserter 105. The compactor 110 may also query the model generator 107 to obtain the mean μ(pᵢ) and standard deviation σ(pᵢ) of a particular process pᵢ directly if this process has been running for a long time as opposed to relying on classifier-based statistics. In this case the mean μ(pᵢ) and standard deviation σ(pᵢ) are calculated directly from this processes previous resource usage information stored in the data collector 108.

In summary the present invention enables using both average and variability of resource demands in decision making, significantly improving the ability to trade-off quality-of-service control with required resources. Further the present invention enables data analyses of actual resource usage of processes in particular media processes in real time to discover statistical patterns of resource usage on per-process basis and clustering/classification of processes. The present invention further enables conversion of raw resource usage data into preferably media, process-specific statistical determination used subsequently in decision making about process placement and optimization within the distributed computing system. The present invention further enables an extraction of feature sets from processed description preferably media process descriptions as an enabler for unique classification and clustering into process categories. Even further the present invention provides real time learning loop for continuous updating of models used to a certain new process resource requirement and making compaction component more tuned to new data as time progresses. Even further the present invention enables squeezing out inefficient process allocation when processes terminate and worker machines under utilized and the ability to control an amount of slack, i.e. redundant, machines for a fast start up of processes based on parameters that may depend on the previous history of process arrival into the distributed computing system.

The present invention guaranties quality of service for processes, in particular media processes in SLA-like terms, for example “this is . . . not permit a worker machine to run over 100% CPU usage over 1% of the time”. Average and variation of processes are taken into consideration. Further the present invention provides a trade-off between the number of working machines and quality-of-services and the ability to learn process characteristics from historical data and use this to influence resource allocation decisions in distributed computing systems. The present invention further allows a more precise determination of resource usage of processes by consideration of statistical information. The present invention allows to accurately predict a fraction of time when a working machine would be over its maximum capability when multiple processes are running on the worker machine. Further, the present invention has the advantage that the user is provided with a fine grained tool by using q-values threshold to determine how much resource usage should be assigned to the processes in the distributed computing system. The present invention further provides fast process start up by maintaining slack capacity so that processes do not have to wait for working machines to start up.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for executing processes preferably media processes (102) on a worker machine (111) of a distributed computing system (1), with a plurality of worker machines (111, 112), comprising the steps of
a) Selecting one of the worker machines (111) out of the plurality of worker machines (111, 112) for execution of a process (102) to be executed in the distributed computing system (1) and transferring said process (102) to the selected worker machine (111),
b) Executing the transferred process (102) on the selected worker machine (111), and
c) Removing the executed process (102) from the selected worker machine (111) after finishing of the execution of the process (102),
characterized in that
statistical information of resource usage of the process (102) to be executed on one of the worker machines (111) is collected and that the selection of the one worker machine (111) is based on a probability resource usage qualifier, wherein the probability resource usage qualifier is extracted from combined statistical information of the process (102) to be executed and already executed and/or executing processes (102) on the worker machine (111).

2. The method according to claim 1, characterized in that the process (102) is classified into a process class according to statistical information of resource usage of a process (102) to be executed, wherein processes (102) in the same process class have similar resource usage characteristics.

3. The method according to claim 2, characterized in that processes (102) in the same process class have the same type of content data, preferably media content data, to be processed.

4. The method according to claim 1, characterized in that working machines (111, 112) having no processes (102) to execute are either shutdown or assigned to be a slack machine (112), wherein a slack machine (112) is kept idle for execution of future processes (102).

5. The method according to claim 1, characterized in that a process on a first worker machine (111) having a first probability resource usage qualifier is moved to a second worker machine (111) having a second probability resource usage qualifier when the second probability resource usage qualifier is higher than the first probability resource usage qualifier.

6. The method according to claim 5, characterized in that a moving of a process to another worker machine (111) is checked when another process (102) on a worker machine (111) is terminated on that worker machine (111).

7. The method according to claim 5, characterized in that a moving of a process to another worker machine (111) is only performed if the number of worker machines (111) having an inefficient resource usage is below a fragment threshold.

8. The method according to claim 4, characterized in that the number of slack machines (112) is determined according to a parameter, wherein the parameter is dependant on process classes, statistical information of processes (102) to be executed and/or executing and/or the rate of processes to be executed and/or terminated on the distributed computing system (1).

9. The method according to claim 1, characterized in that process classes are determined by K-means clustering, hierarchical clustering, using of neural networks and/or using of a support vector machine.

10. The method according to claim 1, characterized in that resource usage of processes executed on the distributed computing system (1) are collected periodically.

11. The method according to claim 1, characterized in that the probability resource usage qualifier represents a probability of a process (102) exceeding a predefined maximum resource usage on a worker machine (111).

12. The method according to claim 1, characterized in that the combined statistical information of the process (102) to be executed and already executed and/or executing processes (102) on the worker machine (111) are weighed for extraction of the probability resource usage qualifier.

13. The method according to claim 1, characterized in that the probability resource usage qualifier for media processes (102) following a Gaussian distribution for resource usage is based on the corresponding Q-function.

14. The method according to claim 1, characterized in that the worker machine (111) having the highest probability resource usage qualifier below a certain threshold is selected for execution of the process (102).

15. Distributed computing system (1) for executing processes (102), preferably media processes and preferably for execution with the method according to claim 1, comprising
a plurality of worker machines (111, 112) for execution of processes (102) in the distributed computing system (1) and
an inserter (105) for selecting one of the worker machines (111, 112) out of the plurality of worker machines (111, 112) for execution of a process (102) to be executed and transferring said process (102) to the selected worker machine (111) for execution,
characterized by
the inserter (105) being operable to select one worker machine (111) based on a probability resource usage qualifier, wherein the probability resource usage qualifier is extracted from combined statistical resource usage information of the process (102) to be executed and already executed and/or executing processes.

16. The distributed computing system according to claim 15, characterized by a classifier (106) for classifying the process (102) to be executed into a process class, wherein processes (102) in the same process class have similar resource usages.

17. The distributed computing system according to claim 15, characterized by a model generator (107) for generating and/or updating a model for different process classes, preferably based on data from executed and/or executing processes (102).

18. Use of the method according to claim 1 and/or the distributed computing system according to one of the claims 15-17 for executing media processes.
